(19) United States
(12) Patent Application Publication
(10) Pub. No.: US 2007/0061157 A1
(43) Pub. Date: Mar. 15, 2007

(54) Obligation assignment systems and methods

(75) Inventors: Greg Fry, Golden, CO (US); Robert Walker, Atlanta, GA (US); Kim Jacksi, Denver, CO (US); Richard Kohara, Denver, CO (US); Kathleen Lucero, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 11/223,065

(22) Filed: Sep. 9, 2005

(51) Int. Cl. G06Q 99/00

(52) U.S. Cl. 705/1

(57) ABSTRACT

Systems, methods, and machine-readable mediums are disclosed for managing assignment of obligations. In one embodiment, the method comprises receiving, at a compliance assurance system, an indication of a termination of employment of an individual and determining, with the compliance assurance system, the individual was assigned an obligation. A new responsible individual for the obligation is determined and the obligation is automatically assigned to the new responsible individual.

### CROSS-REFERENCE TO RELATED APPLICATIONS

This application is related to U.S. patent application Ser. No. ______, entitled “Compliance Management Using Complexity Factors,” filed Sep. 9, 2005 (Attorney Docket No. 020366-097500US) and U.S. patent application Ser. No. ______, entitled “Compliance Assurance Systems and Methods,” filed Sep. 9, 2005 (Attorney Docket No. 020366-097600US). The details of the aforementioned applications are hereby incorporated by reference.

### BACKGROUND OF THE INVENTION

A company may be impacted by a myriad of laws and regulations which govern the conduct of its business. For some types of businesses, the number of laws and regulations may number in the tens of thousands. This is particularly true of regulated businesses, such as telecommunication providers.

Many of the laws or regulations may require a company to demonstrate compliance with the law/regulation. For example, each state in which a company does business may require periodic filings with multiple government agencies. A company may face significant costs and exposure for failure to comply with its legal obligations. Additionally, even though a company may be in compliance, failure to demonstrate the compliance (e.g., file a required report) can also result in heavy fines and penalties being imposed on the company.

As can be appreciated, the number of employees and processes involved in compliance issues may be very large. An extraordinary amount of time, resources, and coordination are required to ensure a company complies with its many legal obligations. Thus, systems and methods to increase the effectiveness of compliance with legal obligations, while minimizing the cost burden, are needed.

### BRIEF SUMMARY OF THE INVENTION

Systems, methods, and machine-readable mediums are disclosed for managing assignment of obligations. In some embodiments, the method comprises receiving, at a compliance assurance system, an indication of a termination of employment of an individual. The compliance assurance system determines the individual was assigned an obligation and also determines a new responsible individual for the obligation. By way of example, the new responsible individual may be determined by determining a manager of the individual. The obligation is automatically assigned to the new responsible individual. The method may also comprise transmitting an assignment notification to the new responsible individual.

In some aspects, the obligation may comprise ownership of a legal obligation. In other aspects, the obligation may comprise ownership of an assurance plan specifying one or more actions to verify compliance with a legal obligation. In still further aspects, the obligation may alternatively comprise ownership of a compliance plan which specifies one or more actions to comply with a legal obligation. In these instances, the method may additionally comprise determining an assurance owner responsible for verifying compliance with the legal obligation and transmitting an assignment notification to the assurance owner.

The method may, in further embodiments, comprise receiving a workflow action to re-assign the obligation to a second individual. An assignment notification is sent to the individual. In some instances, a workflow status may be received indicating the second individual accepts responsibility for the obligation. Alternatively, a workflow status may be received indicating the second individual declines responsibility for the obligation. In these aspects, a notification may be transmitted to an administrator that the second individual declined responsibility.

In further aspects, the method may comprise determining a trigger associated with the obligation has occurred. A notification associated with the trigger may be transmitted to the new responsible individual. By way of example, the notification may indicate an impending due date for a compliance plan execution. As another example, the notification may indicate an impending due date for an assurance plan execution.

In other embodiments, a compliance assurance system is disclosed which comprises an interface and logic. The interface is configured to receive a termination notification indicating a terminated employee. Optionally, the compliance assurance system may comprise a human resource system, communicatively coupled with the interface, to transmit the termination notification. The logic is communicatively coupled with the interface and is configured to determine the individual was assigned an obligation. The logic is also configured to determine a new responsible individual for the obligation and to automatically assign the obligation to the new responsible individual.

The compliance assurance system may further comprise a data store communicatively coupled with the logic. The data store may include a plurality of legal obligations and a plurality of compliance plans. Each of the compliance plans is associated with one of the legal obligations. The compliance plans each specify at least one action to comply with the associated legal obligation. In these aspects, the obligation assigned to the new responsible individual may comprise ownership of one of the legal obligations or ownership of one of the compliance plans.

The data store may, in further embodiments, include an assurance plan associated with one of the legal obligations. The assurance plan specifies one or more actions to verify compliance with the associated legal obligation. In these embodiments, the interface may be further configured to receive a second termination notification indicating a second terminated individual. The logic may be further configured to determine the second terminated individual was assigned ownership of the assurance plan. The logic also is configure to determine a new responsible assurance plan owner for the assurance plan.

A further understanding of the nature and advantages of the present invention may be realized by reference to the remaining portions of the specification and the drawings.

### BRIEF DESCRIPTION OF THE DRAWINGS

Illustrative embodiments in accordance with the invention are illustrated in the drawings in which:

FIG. 1 illustrates an exemplary embodiment of a system including a compliance assurance system to manage legal obligations;

FIG. 2 is a block diagram of an exemplary components of a compliance assurance system;

FIG. 3 is a block diagram of an exemplary data store that may be used by a compliance assurance system;

FIG. 4 illustrates one exemplary relationship between a legal obligation and compliance plans to comply with the legal obligation;

FIG. 5 illustrates a second exemplary relationship between a legal obligation and compliance plans;

FIG. 6 illustrates another exemplary relationship between a legal obligation and compliance plans;

FIG. 7 is a block diagram of an exemplary computer system upon which a compliance assurance system or components of a compliance assurance system may be implemented;

FIG. 8 is a flow diagram illustrating an exemplary method that may be used to initiate compliance management of a legal obligation;

FIG. 9 is a flow diagram illustrating exemplary management of a legal obligation using a compliance assurance system;

FIG. 10 is a flow diagram illustrating exemplary management of legal obligations using complexity factors; and

FIG. 11 is a flow diagram illustrating an exemplary method that may be used to re-assign compliance obligations.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

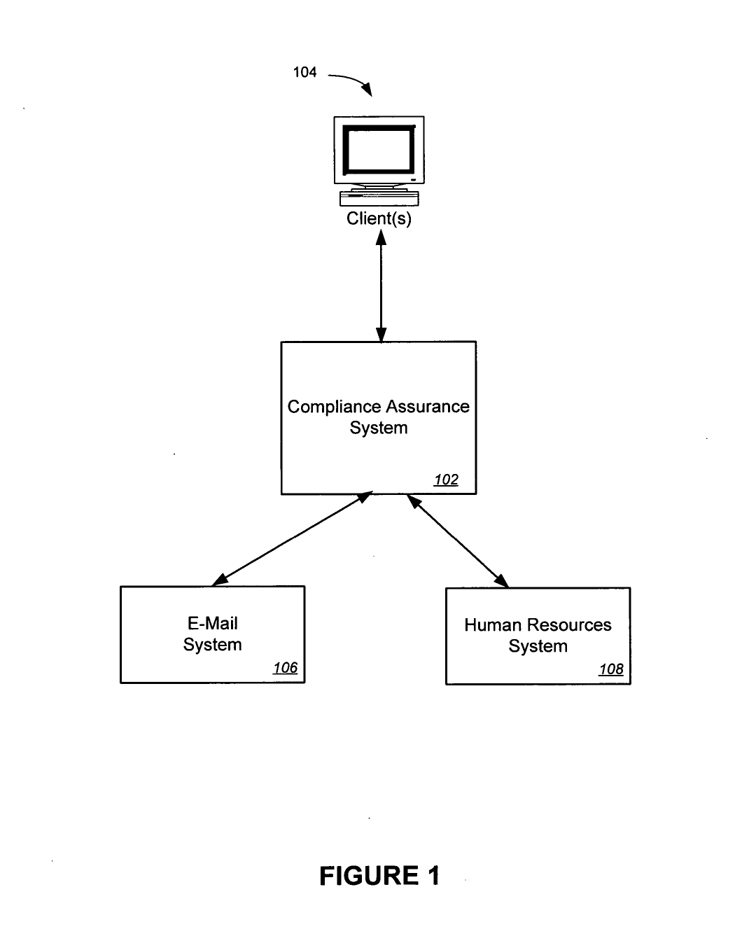

FIG. 1 illustrates an exemplary embodiment of a system including a compliance assurance system to manage legal obligations. The system includes a compliance assurance system 102, an e-mail system 106, a human resources system 108, and one or more client(s) 104.

Compliance assurance system 102 may be used by a company to track and manage compliance with its legal obligations. Merely by way of example, the legal obligations managed by compliance assurance system 102 may include federal statutes, federal regulations, state statutes, state regulations, enforcement actions (e.g., Consent Decrees, Agreements of Voluntary Compliance), and/or other type of legal obligation. The compliance assurance system 102 may be used to support compliance planning, implementation, and/or compliance assurance for legal obligations. Further details of functionality that may be included or provided by compliance assurance system 102 are described below.

Users may interact with compliance assurance system 102 using client computer(s) 104. The client computer(s) 104 may be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems. Client computer(s) 104 may also have any of a variety of applications, including for example, database client and/or server applications, and web browser applications. Alternatively, client(s) 104 may be any other electronic device, such as a thin-client computer, Internet-enabled mobile telephone, and/or personal digital assistant, capable of communicating with compliance assurance system 102 and/or displaying and navigating web pages or other types of electronic documents.

In some aspects, compliance assurance system 102 may communicate with an electronic mail system 106. E-Mail system 106 may be used by compliance assurance system 102 to send notifications related to compliance issues. By way of example, the notifications may include work assignment notifications and/or notifications of due dates. It should be appreciated that other mechanisms may also be used by compliance assurance system 102 to send notifications. For instances, notifications may be sent to mobile devices (e.g., using text messaging), via facsimile, or via any other appropriate communication mechanism. Thus, compliance assurance system 102 may interact with additional or alternative systems other than e-mail system 106 to send notifications and/or may directly transmit notifications to recipients. In other embodiments, compliance assurance system 102 may not transmit notifications.

Compliance assurance system 102 may, in some embodiments, communicate with a human resources system 108. Human resources system 108 may contain personnel records and employment status of employees/contractors. This information may be used by compliance assurance system 102 to manage the assignment of legal obligations. For example, compliance assurance system 102 may receive (upon request and/or asynchronously) notifications regarding the termination of employment of employees/contractors. Upon receiving a termination notification, compliance assurance system 102 may re-assign obligations that were previously assigned to the terminated individual. The re-assignment of obligations will be described in more detail below. In other embodiments, compliance assurance system may not communicate with human resources system 108.

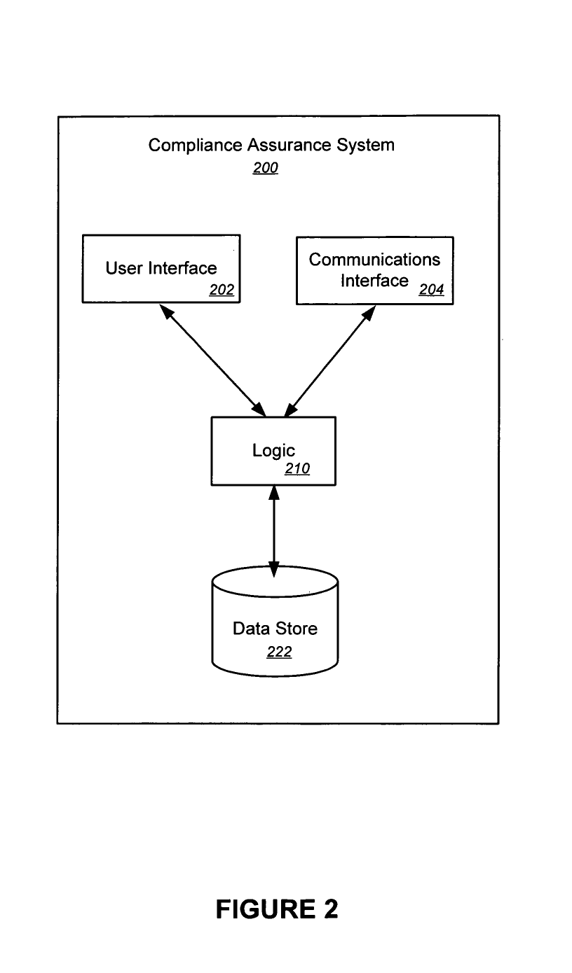

FIG. 2 illustrates an exemplary embodiment of components of a compliance assurance system 200. Compliance assurance system 200 may include logic 210 communicatively coupled with one or more interfaces, such as user interface 202 and/or communications interface 204. The compliance assurance system 200 may also include a data store 220 communicatively coupled with logic 210.

User interface 202 may be any type of interface, such as an Internet browser, other type of graphical user interface (GUI) or non-GUI interface that allows a user to interact with compliance assurance system. User interface 202 may be used to obtain inputs from users (e.g., legal obligation information, compliance plans, assurance plans, workflow status, compliance updates, compliance evidence) and to receive requests from users. User interface 202 may also be used to provide information to users (e.g., display data or reports, display notifications).

Communications interface 204 may be used to communicate with other systems, such as an e-mail system or human resources system. Merely by way of example, communications interface 204 may comprise an interface to a public network (e.g., the Internet) and/or an interface to a proprietary network. Other types of communications interfaces are also contemplated. In some aspects, user interface 202 and communications interface 204 may share the same physical interface to a machine.

Logic 210 may be one or more software programs, one or more components of a software program (e.g., function or program object), firmware, or other type of machine-executable instructions that may be used to manage compliance with legal obligations. In some aspects, logic 210 may include database application logic to create, update, delete, and/or retrieve data stored in data store 220.

Forms or other user input mechanisms may be created by logic 210. The forms may allow a user to enter, edit, or delete compliance management data. For example, logic 210 may create forms that allow users to enter and update information about legal obligations, compliance plans which include information about how the company will comply with a legal obligation, assurance plans which include information about how compliance with a legal obligation will be verified, and/or other information used to manage or track compliance with legal obligations.

Logic 210 may also be used to create reports of information included in data store 220. The reports may be created by logic 210 upon receiving a user request for a report. Alternatively, or additionally, logic 210 may create reports at predetermined time intervals or upon occurrence of other types of triggers or events. The reports may then be transmitted to designated recipient(s). A few exemplary reports that may be created by logic 210 will be described below. It should, however, be appreciated that reports other than those described herein may also be created by logic 210.

In some embodiments, logic 210 may perform additional functionality related to the management of compliance with legal obligations. For example, logic 210 may include functionality to send notifications and/or other types of information to users. As another example, logic 210 may be used to re-assign obligations that were previously assigned to terminated employees/contractors. Further details of the functionality that may be performed by logic 210 are described below.

Compliance assurance system 200 may also include a data store 220, communicatively coupled with logic 210. Data store 220 may be one or more relational databases (e.g., a database adapted to store, update, and retrieve data in response to SQL-formatted commands), spreadsheet(s), text file(s), internal software list(s), or other type of data structure(s) suitable for storing data. Data store 220, or components of data store 220, may reside in one or more physical locations.

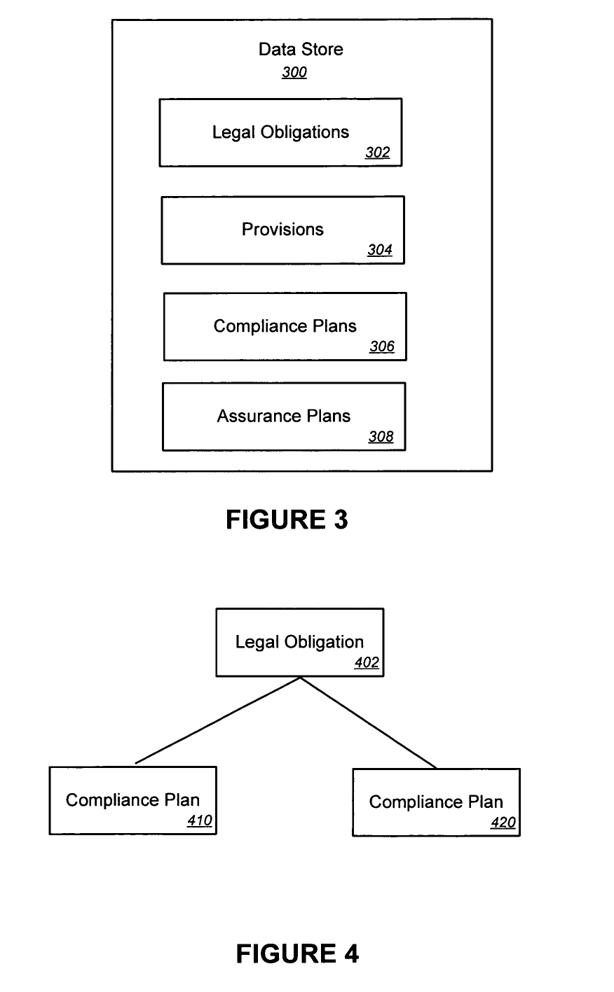

Data store 220 may be used as to store information used to manage or track compliance with legal obligations. Exemplary information that may be stored by data store 220 will be described in more detail with reference to FIG. 3.

In the configuration described above, different components were described as being communicatively coupled to other components. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that logic 210, user interface 202, communications interface 204, and data store 222 may reside on the same or different physical devices. By way of example, user interface 202 may be a web browser on a remote client. Additionally, it should be appreciated that in alternate embodiments, the system described in FIG. 2 may contain additional or fewer components than described and/or the compliance assurance system components 202, 204, 210, 222 described may perform additional, less, or alternative functionality than described.

FIG. 3 illustrates exemplary components of a data store 300 that may be used by a compliance assurance system to store data related to the management or tracking of compliance with legal obligations. The data store 300 may include information about a plurality of legal obligations 302, provisions 304 of legal obligations, compliance plans 306, and/or assurance plans 308.

Legal obligations may be records or other type of data structure used to store attributes associated with legal obligations that impose a compliance obligation on a company. The legal obligations may be federal statutes, federal regulations, state statutes, state regulations, enforcement actions, and/or other type of legal obligation. Complex legal obligations may, in some aspects, be broken out into separate legal obligations (e.g., sections of a federal statute/regulation) to facilitate easier compliance management.

Depending upon the needs of a company, any number of different attributes may be associated with a legal obligation 302. Exemplary attributes of a legal obligation may include legal obligation identifier(s) (e.g., name, numeric identifier, statute number, regulation number), date the obligation was enacted, date the legal obligation expires (if any), jurisdiction entity that created the obligation, jurisdiction, type of legal obligation, business entity and/or department(s) impacted by the obligation, legal subject matter expert, and/or synopsis of the legal obligation.

A legal obligation 302 may also have an attribute indicating an owner of the legal obligation. The owner of the legal obligation may be responsible for assuring compliance with the legal obligation. In some instances, the legal obligation may be managed by more than one individual. In these instances, the legal obligation may also have attributes for delegate owners and/or co-owners of the obligation.

Another attribute of a legal obligation 302 may be a status attribute used to indicate a status of the legal obligation. Merely by way of example, a legal obligation may have an associated status of active, open, closed, inactive, or pending. An active status may indicate that the legal obligation imposes future obligations (e.g., training, reporting) on a company. An open status may be used when there are no future compliance requirements (e.g., obligations were fulfilled and/or implemented), but the company is still bound by the obligation. A closed status may indicate that the obligation expired or otherwise does not impose any further obligations. Legal obligations that are on-hold or are not applicable may have an inactive status. A pending status may be associated with legal obligations that have not yet been enacted, but will likely be enacted in the future. In other embodiments, different status types may be used to indicate a status of a legal obligation.

Legal obligations may, in some aspects, have an attribute indicating a workflow status of the legal obligation. Merely by way of example, the workflow status may indicate the legal obligation is unassigned, assigned—work in progress (indicating that compliance assurance development work is currently in progress, such as development of compliance plans and/or assurance plans), or assigned-implemented. An out-of-scope workflow status may be used to indicate that the legal obligation does not apply to the company or is outside the scope of compliance management (e.g., taxes). In other embodiments, additional, alternative, or fewer status categories may be used to indicate the workflow status of legal obligations.

Another exemplary attribute of a legal obligation 302 is a complexity factor attribute. A complexity factor may be used to indicate a complexity of complying with the legal obligation. The complexity factors may then be used by a company to allocate resources, determine auditing schedules, and/or otherwise manage legal obligations.

Merely by way of example, a complexity factor may comprise one of three levels indicating either a high degree of complexity, a medium degree of complexity, or a low degree of complexity. Obligations may be assigned a complexity factor indicating a high degree of complexity if the legal obligation implements a new rule, the legal obligation is complex (e.g., subject to interpretation, involves multiple business units or systems), compliance with the legal obligation is difficult to validate, compliance with the legal obligation relies heavily on manual processes, new processes are required to comply with the legal obligation, and/or other factors indicate that a high degree of complexity is involved in managing compliance with the legal obligation. A second level, indicating a medium degree of complexity, may be used if the legal obligation modifies an existing rule, compliance with the legal obligation uses a combination of manual and mechanized processes, lack of compliance results in significant penalties, and/or any other factors indicate that a medium degree of complexity is involved in complying with the legal obligation. A complexity factor indicating a low degree of complexity may be used for those legal obligations associated with stable rules and/or reliable processes. It should be appreciated that alternative categories and/or categorization criteria may be used to assign a legal obligation a complexity factor. Additionally, in some embodiments, a legal obligation may have multiple complexity factor attributes, each indicating a different aspect of complexity.

Legal obligations 302 may also be associated with documents and/or notes stored in data store 300. Documents associated with a legal obligation may include document(s) containing a copy of the official legal obligation, evidence documents containing evidence that the company complies with the legal obligation, minutes recording meeting notes, and/or any other type of document related to the legal obligation. In some aspects, the documents and/or notes may be assigned a security level indicating view permissions associated with the document/note. For example, a document or note may be assigned a public security level allowing all users with permission to view the legal obligation to view the document/note, a private security level allowing only the individual who created the document/note to view it, or a user-defined security level allowing the creator of the note/document to define the individuals that may view the document/note. This may allow attorney-client privileged documents or other private documents to be stored in data store 300.

In some instances, management of a legal obligation may be facilitated by separating the obligation into multiple provisions 304 for different aspects of the legal obligation. Merely by way of example, provisions may be used when a legal obligation requires actions from different business groups or when different types of actions are required. As will be described in more detail below, compliance and/or assurance plans may then be associated with a provision, instead of the legal obligation.

A provision 304 may also have various attributes associated with it. The attributes may be different according to the needs of a company. Exemplary attributes that may be used include provision identifier(s) (e.g., title, numeric reference), effective date, expiration date, text of the provision, and/or interpretation of the provision. Other attributes may also be associated with a provision 304. In some aspects, notes and/or documents may be attached to a provision, similar to that described above with reference to notes/documents attached to legal obligations.

Legal obligations 302 and/or provisions 304 may have one or more compliance plans 306 associated with them. The compliance plans 306 may specify how a company or organization within the company will comply with the associated legal obligation 302 or provision 304. One or more detail attribute(s) may be associated with a compliance plan 306 to indicate the action(s) required to keep the company in compliance with the legal obligation. The compliance plan detail(s) may be used to specify the who, what, when, and where information for complying with a legal obligation or provision. Other exemplary attributes that may be associated with a compliance plan 306 include a title of the compliance plan, a compliance plan owner, a recurrence frequency for executing the compliance plan (e.g., one time, quarterly, monthly, conditional), a date range for the recurrence frequency (i.e., start and stop dates), and/or a due date for compliance plans with a one time frequency of recurrence.

Another exemplary attribute that may be associated with a compliance plan 306 is an attribute for the compliance type. The compliance type may indicate the nature of the action(s) associated with the compliance plan 306. By way of example a compliance plan may have a compliance type of no action, produce report, make payment, develop or implement a policy or process, training, filing requirement, notice requirement, or any other suitable compliance type category.

Other types of compliance plan attributes are also contemplated. For instances, an opportunity identification attribute may be provided to allow a user to input suggestions to improve compliance and/or lessen the burden of compliance. As another example, compliance plan notification(s) may be associated with a compliance plan 306 to send recipients a message about the compliance plan (e.g., notify recipients of impending due dates). Compliance plan notifications will be described in further detail below. In some aspects, notes and/or documents may be associated with a compliance plan 306 in a similar fashion to that described above with reference to notes/documents associated with legal obligations 302.

A legal obligation 302 or provision 304 may also have one or more assurance plans 308 associated with the legal obligation/provision. An assurance plan may specify action(s) required to verify compliance with the obligation. Thus, an assurance plan 308 may include one or more detail attribute(s) specifying the who, what, where, and when of actions(s) taken to verify compliance. An assurance plan 308 may also have an assurance plan owner attribute. As another example, an assurance plan 308 may have a recurrence frequency attribute to indicate the frequency of executing the assurance plan. It should be appreciated that the recurrence frequency of an assurance plan for a legal obligation may differ from the recurrence frequency of a compliance plan for the legal obligation. Notes and/or documents stored in data store 300 may also be associated with an assurance plan. It should be appreciated that other attributes may also be associated with an assurance plan 308.

In alternative embodiments, data store 300 may not include all of the data components shown in FIG. 3 or may include additional or alternative components. Furthermore, each of the components 302, 304, 206, 308 may include additional, fewer, or alternative attributes than described.

FIGS. 4-6 illustrate exemplary relationships between legal obligations, compliance plans, and provisions. It should be appreciated that similar relationships may exist between legal obligations, provisions and assurance plans.

In FIG. 4, compliance plans 410, 420 are associated directly with legal obligation 402. This type of relationship may be used for legal obligations that are not complex. In some embodiments, a legal obligation 402 with this relationship may have several compliance requirements, each of which may have its own compliance plan 410, 420. Other reasons for creating separate compliance plans, such as different types of actions or different compliance owners may also result in the creation of multiple compliance plans 410, 420 associated with a legal obligation 402. In alternative embodiments, a legal obligation 402 may have fewer or additional associated compliance plans 410, 420.

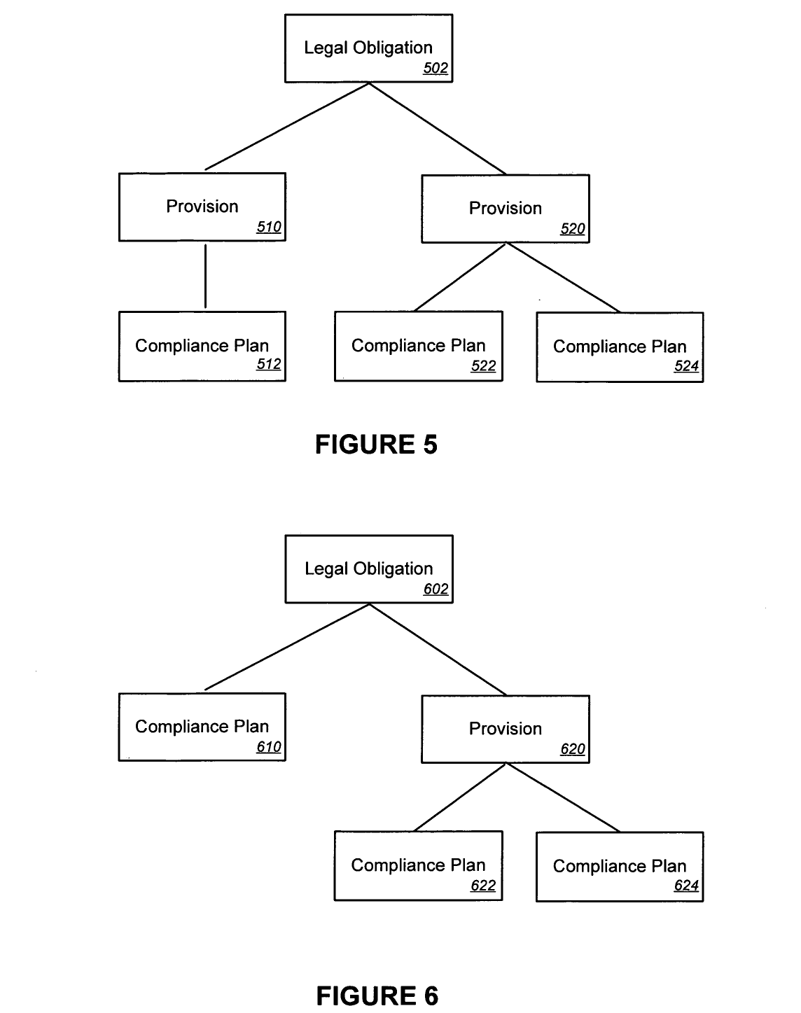

FIG. 5 illustrates a relationship that may be used for a complex obligation. To facilitate management of a complex legal obligation 502, the legal obligation may be broken into multiple provisions 510, 520. One or more compliance plans 512, 522, 524 may then be created for each of the provisions 510, 520.

The legal obligation 502 may be divided into provisions 510, 520 using any appropriate division that may help a company/organization manage compliance with the legal obligation 502. For example, provisions 510, 520 may be created when different groups within the company manage different pieces of the obligation. Other reasons for dividing a legal obligation 502 into multiple provisions 510, 520 also exist.

FIG. 6 illustrates a type of relationship which is a combination of the types of relationships shown in FIGS. 4 and 5. In this example, the legal obligation 602 has one or more compliance plans 610 associated directly with the legal obligation 602 (e.g., for simple requirements of the legal obligation). The legal obligation 602 may also have one or more provisions 620 for complex requirements of the legal obligation. Each provision 620 may then have one or more associated compliance plans 622, 624.

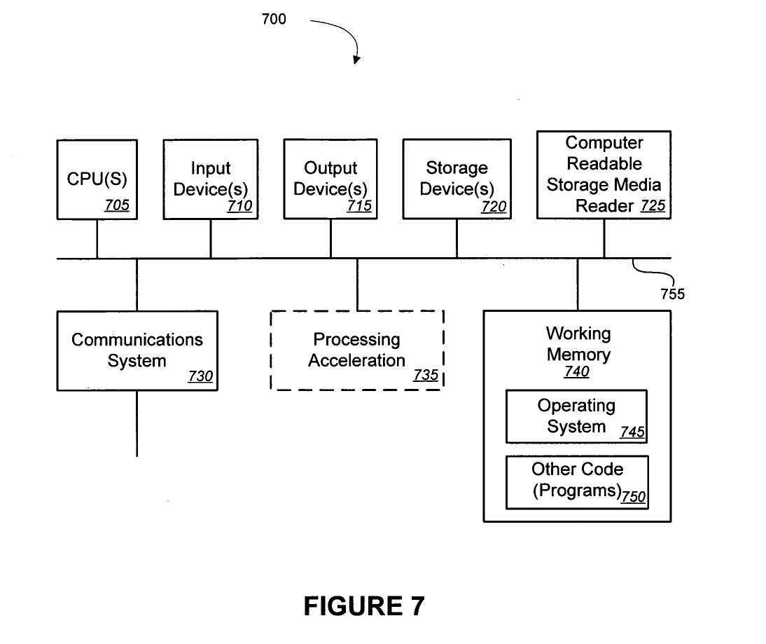

FIG. 7 illustrates one embodiment of a computer system 700 upon which a compliance assurance system or components of a compliance assurance system may be implemented. The computer system 700 is shown comprising hardware elements that may be electrically coupled via a bus 755. The hardware elements may include one or more central processing units (CPUs) 705; one or more input devices 710 (e.g., a scan device, a mouse, a keyboard, etc.); and one or more output devices 715 (e.g., a display device, a printer, etc.). The computer system 700 may also include one or more storage device 720. By way of example, storage device(s) 720 may be disk drives, optical storage devices, solid-state storage device such as a random access memory (“RAM”) and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735 , which can include a DSP, a special-purpose processor and/or the like.

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with a network and/or any other computer or other type of device.

The computer system 700 may also comprise software elements, shown as being currently located within a working memory 740, including an operating system 745 and/or other code 750, such as an application program. The application programs may implement a compliance assurance system, components of a compliance assurance system, and/or the methods of the invention. It should be appreciate that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

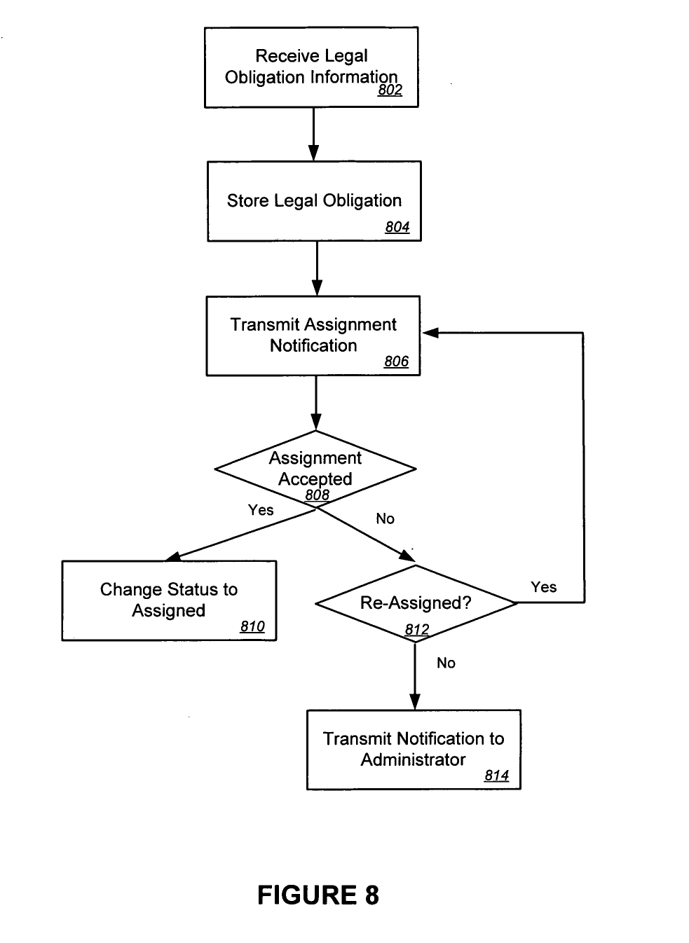

FIG. 8 illustrates an exemplary method that may be used to initiate compliance management of a legal obligation. The method may begin by receiving 802 legal obligation information for a legal obligation. By way of example, the legal obligation information may be received 802 by a user, such as a compliance administrator or other designated individual, entering the legal obligation information in a form provided by a user interface. Other mechanisms may also be used to receive 802 the legal obligation information.

The legal obligation information may include a description of the legal obligation and/or a candidate assurance owner responsible for verifying compliance with the legal obligation. The legal obligation information may also include any of the other attributes previously described with reference to FIG. 3. At block 804, the legal obligation information is stored in a data store.

After the candidate assurance owner for a legal obligation is received, an assignment notification may be transmitted 806 to the candidate assurance owner. Additional individuals may also receive the assignment notification. In some embodiments, the assignment notification may be transmitted 806 in an e-mail message. In other embodiments, different notification mechanisms, such as fax or mobile device messaging, may alternatively or additionally be used to transmit 806 an assignment notification to a candidate assurance owner.

The candidate assurance owner may then access the compliance assurance system to accept or reject ownership of the legal obligation. In some embodiments, the candidate assurance owner may access a form, or other display mechanism, associated with the legal obligation to accept or decline responsibility for the legal obligation. In other embodiments, the candidate assurance owner may be able to accept or reject the assignment by responding to the notification.

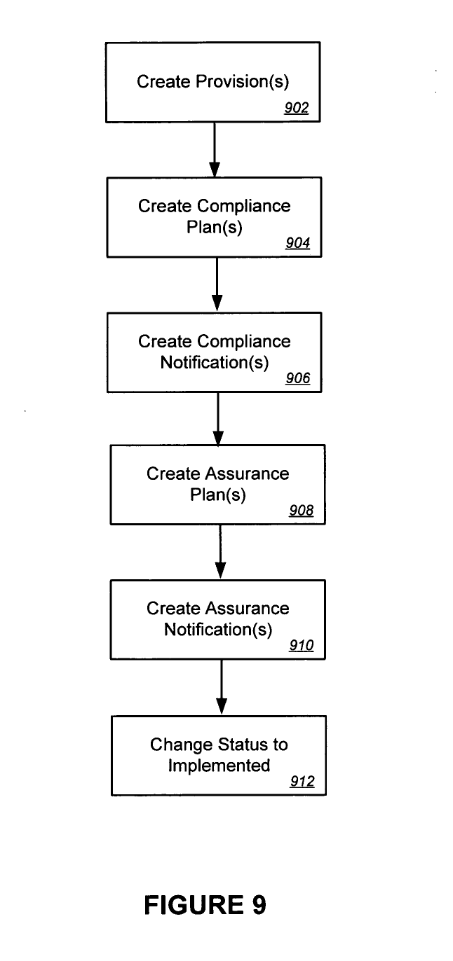

If 808 an indication is received that the candidate assurance owner accepts responsibility for the legal obligation, a workflow status associated with the legal obligation may be changed 810 to an assigned status. In other embodiments, the workflow status may be changed 810 to assigned at the time the candidate assurance owner for the legal obligation is received 802. After the candidate assurance owner accepts responsibility for the legal obligation, the candidate assurance owner or delegated individuals may use the compliance assurance system to perform compliance management tasks, such as those described with reference to FIG. 9.

The candidate assurance owner may also choose to decline responsibility for the legal obligation. In some embodiments, the candidate assurance owner may be given the option to re-assign the legal obligations to another individual. In these embodiments, if 812 the candidate assurance owner re-assigns the obligation, the method may continue back at block 806, at which an assignment notification is transmitted to the new candidate assurance owner.

Otherwise, if 808 the candidate assurance owner declines responsibility and does not re-assign the obligation, a notification may be transmitted 814 to a compliance administrator. The candidate assurance owner may, in some aspects, provide or be required to provide, a reason for declining responsibility for the obligation. By way of example, the candidate assurance owner may decline responsibility for the obligation if he or she does not believe the legal obligation applies to the company or if the obligation is outside his or her area of responsibility or expertise. The reason that responsibility for the legal obligation was declined may be stored 804 in data store and/or transmitted to the administrator. The administrator may then determine a new candidate assurance owner or may assign the legal obligation a status indicating the obligation is out of scope.

FIG. 9 is a flow diagram illustrating exemplary interactions with a compliance assurance system that may take place during the course of managing compliance with a legal obligation. These interactions may take place by a user interacting with a user interface, such as that described with reference to FIG. 2. Other appropriate mechanisms may also be used to receive information from a user.

Once an individual has been assigned ownership of a legal obligation, the individual, or other delegated individuals, may create 902 one or more provisions for the legal obligation. The creation of provisions may allow the owner to more easily manage compliance with the legal obligation. A provision for a legal obligation may include any of the attributes previously described or any other desired attribute. In some cases or embodiments, provisions may not be created for a legal obligation.

Another type of interaction that may take place is the creation 904 of one or more compliance plans. A compliance plan may be directly associated with a legal obligation or may be associated with a provision of a legal obligation (indirectly associated). The compliance plans may each specify at least one action to comply with the associated legal obligation/provision. The user may also input other attributes of the compliance plan into the compliance assurance system, such as a compliance owner, a compliance type, a recurrence frequency, or any other type of attribute (e.g., any of the attributes previously described) about the compliance plan.

A user, such as a compliance plan owner or legal obligation owner, may also create 906 compliance notification(s) for a compliance plan. To create 906 a compliance notification, the user may specify the text of the notification and one or more recipients of the notification. For instances, the text of a notification may notify the recipient(s) of an impending due date or a compliance obligation associated with the compliance plan (e.g., creation of a report, filing information with an agency, etc.). The user may also specify the trigger(s) that trigger transmission of the notification. By way of example, the user may specify a schedule for when the notification is to be sent (one time or on a recurring basis). Other triggers, such as changes of status or completion of an execution occurrence of an assurance plan or compliance plan, may also be specified as triggers for the compliance plan notification. When the compliance assurance system determines that a trigger associated with the compliance plan notification has occurred (e.g., the current date matches a scheduled date), the compliance assurance system may transmit the compliance plan notification, via e-mail or other appropriate means, to the designated recipient(s). In some instances, the communication mechanism to use to transmit the notification may be specified by the creator of the notification.

A user may also interact with the compliance assurance system to create 908 one or more assurance plans for a legal obligation or provision of a legal obligation. An assurance plan may specify one or more actions to verify compliance with the associated legal obligation/provision. An assurance plan may also have other attributes, such as an owner of the assurance plan, a recurrence frequency, or any of the other attributes previously described with reference to FIG. 3.

Assurance notifications 910 may also be created 910 to send notifications to recipients about assurance obligations or other information about an assurance plan. The assurance notifications may be created in a manner similar to that used to create 906 of the compliance notifications. When the compliance assurance system determines a trigger associated with an assurance notification has occurred, the assurance notification may be transmitted to the designated recipient(s) using any appropriate communication mechanism.

After the appropriate compliance plans and/or assurance plans for a legal obligation have been implemented, a workflow status of the legal obligation may be changed 912 to indicate that compliance management of the legal obligation has been implemented.

At various times, compliance obligations, such as the execution of the actions of a compliance plan and/or the execution of an assurance plan may become due. It should be appreciated that a user may then interact with the compliance assurance system to input information about the execution of a compliance plan or assurance plan. In some instances, the compliance assurance system may have calculated a due date for an execution occurrence of a compliance plan or assurance plan based on an associated occurrence schedule. Notifications may have been triggered to notify recipients of impending due dates. After a compliance plan or assurance plan has been executed, the user may input information indicating the execution has been completed. For assurance plans, a result of the compliance audit may also be input. By way of example, the audit result may indicate full compliance with the obligation, partial compliance, or the company is not in compliance with the obligation. Evidence documents illustrating compliance or other types of documents or notes may be added to the compliance data store and associated with the legal obligation, compliance plan, or assurance plan.

It should be appreciated that in other embodiments, all of the interactions described in FIG. 9 may not be performed. Additionally, it should be appreciated that a user may perform other interactions with a compliance assurance system than that described. For example, at any point in time, a user may be able to interact with the compliance assurance system to display reports containing compliance information maintained by the compliance assurance system. One exemplary report that may be created is a report that includes information about the legal obligations assigned to a user or a subset of the legal obligations assigned to a user (e.g., those with an impending due date, those that require further compliance assurance development work). Other types of reports may also be created.

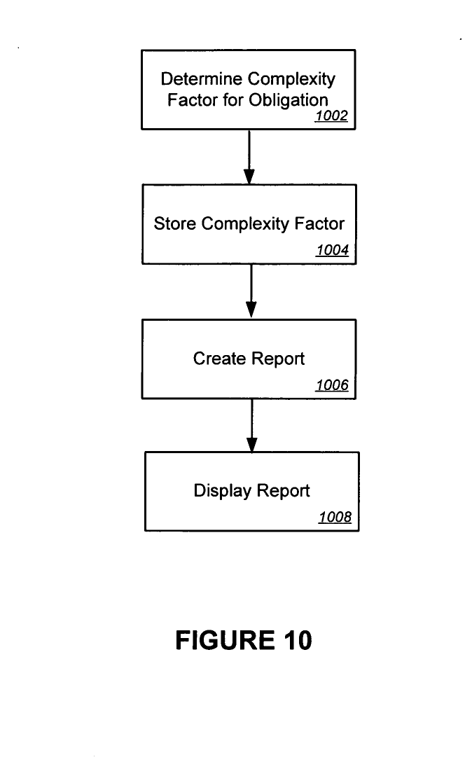

FIG. 10 illustrates exemplary management of legal obligations using complexity factors. As part of the management of legal obligations, complexity factors may be determined 1002 for a legal obligation. The complexity factors may indicate a complexity of complying with the legal obligation. A complexity factor, or factors, for a legal obligation may be determined 1002 based on a variety of different criteria. One exemplary criteria may be the difficulty of validating compliance with the legal obligation. Other exemplary criteria include whether the legal obligation implements a new rule or modification to an existing rule, whether compliance with the legal obligation requires implementation of a new process, or any other criteria, such as the criteria previously described with reference to FIG. 3.

The complexity factor or factors for the legal obligations may be stored 1002 in a data store of the compliance assurance system. The compliance assurance system may, either upon request or at predetermined trigger events (e.g., predetermined times), create 1006 a report categorizing at least some of the legal obligations by their respective complexity factors. By way of example, the report may contain legal obligations that need compliance assurance development work, such as the creation of compliance plans or assurance plans. These obligations may have an associated workflow status indicating work is in progress. As another example, the report may contain the legal obligations assigned to a particular individual. The created report may then be displayed 1008 or otherwise provided to users or other recipients.

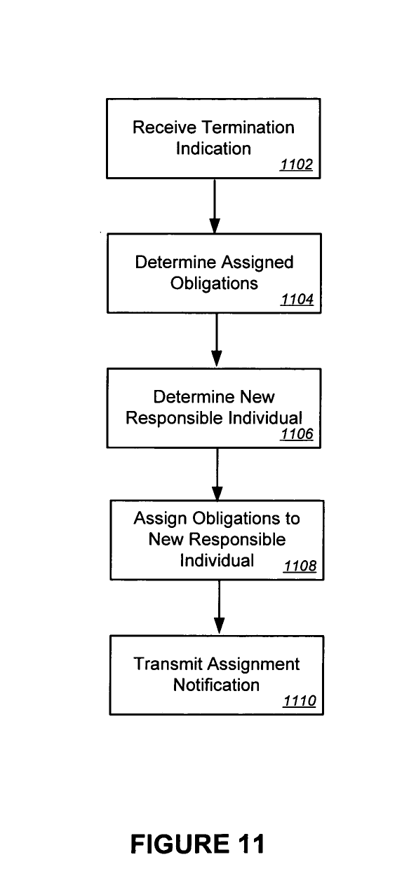

FIG. 11 illustrates an exemplary method that may be used to re-assign compliance obligations when an individual's employment with a company is terminated. The re-assignment process may begin by receiving 1102 a termination indication that an individual's employment with the company has been terminated. The termination indication may be received 1102 from a human resources system, either upon request or without request of the compliance assurance system.

The compliance assurance system may then determine 1104 the terminated individual was assigned one or more compliance obligations. The compliance assurance system may determine the individual was assigned compliance obligation(s) if the individual was assigned ownership of legal obligation(s), ownership of compliance plan(s), and/or ownership of assurance plan(s).

A new responsible individual for each of the compliance obligations may then be determined 1106 by the compliance assurance system. Merely by way of example, the new responsible individual may be determined 1106 by determining the individual's manager. The manager may be obtained from a human resources system or may otherwise be obtained. In other aspects, the compliance assurance system may determine that individuals other than the terminated individual's manager should be assigned responsibility for one or more of the terminated individual's compliance obligations. It should be appreciated that in some cases, the compliance assurance system may not be able to determine 1104 a new responsible individual for a terminated employee's compliance obligation(s). In those instances, a notification may be sent to an administrator or other responsible party to determine the individual to whom responsibility for the obligation should be given.

The compliance assurance system may then automatically assign the compliance obligation(s) to the new responsible individual(s). An assignment notification may then be sent to the new responsible individual(s) notifying the individual(s) of the assignment. Notifications may also be sent to other parties. For example, if the terminated individual was assigned a compliance plan, the owner of the legal obligation and/or assurance plans associated with the legal obligation may also be sent a notification. In some embodiments, the new responsible individual may accept, decline, or re-assign the obligation using a process similar to that described with reference to FIG. 8.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
receiving, at a compliance assurance system, an indication of a termination of employment of an individual;
determining, with the compliance assurance system, the individual was assigned an obligation;
determining, with the compliance assurance system, a new responsible individual for the obligation; and
automatically assigning, with the compliance assurance system, the obligation to the new responsible individual.

2. The method of claim 1, further comprising transmitting an assignment notification to the new responsible individual.

3. The method of claim 1, wherein determining the new responsible individual comprises determining a manager of the individual.

4. The method of claim 1, wherein the obligation comprises ownership of a legal obligation.

5. The method of claim 1, wherein the obligation comprises ownership of a compliance plan specifying one or more actions to comply with a legal obligation.

6. The method of claim 5, further comprising:
determining an assurance owner responsible for verifying compliance with the legal obligation; and
transmitting an assignment notification to the assurance owner.

7. The method of claim 1, wherein the obligation comprises ownership of an assurance plan specifying one or more actions to verify compliance with a legal obligation.

8. The method of claim 1, further comprising:
receiving, at the compliance assurance system, a workflow action to re-assign the obligation to a second individual; and
transmitting, with the compliance assurance system, an assignment notification to the second individual.

9. The method of claim 8, further comprising receiving, at the compliance assurance system, a workflow status indicating the second individual accepts responsibility for the obligation.

10. The method of claim 8, further comprising:
receiving, at the compliance assurance system, a workflow status indicating the second individual declines responsibility for the obligation; and
transmitting, with the compliance assurance system, a notification to an administrator that the second individual declined responsibility.

11. The method of claim 1, further comprising:
determining, with the compliance assurance system, a trigger associated with the obligation has occurred; and
transmitting, with the compliance assurance system, a notification associated with the trigger to the new responsible individual.

12. The method of claim 11, wherein the notification indicates an impending due date for a compliance plan execution.

13. The method of claim 11, wherein the notification indicates an impending due date for an assurance plan execution.

14. A compliance assurance system comprising:
an interface to receive a termination notification indicating a terminated employee; and
logic, communicatively coupled with the interface, to determine the individual was assigned an obligation, to determine a new responsible individual for the obligation, and to automatically assign the obligation to the new responsible individual.

15. The compliance assurance system of claim 14, further comprising:
a data store, communicatively coupled with the logic, the data store including a plurality of legal obligations and a plurality of compliance plans, each of the compliance plans associated with one of the legal obligations, the compliance plans specifying at least one action to comply with the associated legal obligation; and
wherein the obligation comprises one of ownership of one of the legal obligations and ownership of one of the compliance plans.

16. The compliance assurance system of claim 15, wherein:
the data store further includes an assurance plan associated with one of the legal obligations, the assurance plan specifying one or more actions to verify compliance with the associated legal obligation; and
wherein the interface is further to receive a second termination notification indicating a second terminated individual and the logic is further configured to determine the second terminated individual was assigned ownership of the assurance plan and to determine a new responsible assurance plan owner for the assurance plan.

17. The compliance assurance system of claim 14, further comprising a human resource system, communicatively coupled with the interface, to transmit the termination notification.

18. At least one machine-readable medium, having stored thereon sequences of instructions, which, when executed by a machine cause the machine to perform the actions of:
receiving an indication of a termination of employment of an individual;
determining the individual was assigned an obligation;
determining a new responsible individual for the obligation; and
automatically assigning the obligation to the new responsible individual.

19. The machine-readable medium of claim 18, further comprising instructions, which, when executed by the machine, cause the machine to perform the actions of transmitting an assignment notification to the new responsible individual.
